(19) United States
(12) Patent Application Publication
(10) Pub. No.: US 2015/0228255 A1
(43) Pub. Date: Aug. 13, 2015

(54) ELECTRONIC APPARATUS AND CONTROL METHOD FOR THE SAME

(71) Applicant: Kabushiki Kaisha Toshiba, Tokyo (JP)

(72) Inventor: Nobuaki Takasu, Akishima (JP)

(21) Appl. No.: 14/597,968

(22) Filed: Jan. 15, 2015

Related U.S. Application Data
(60) Provisional application No. 61/932,673, filed on Jan. 28, 2014.

(51) Int. Cl. G09G 5/38

(52) U.S. Cl. CPC G09G 5/38; G09G 2340/0492; G09G 2330/021

(57) ABSTRACT

One embodiment provides an electronic apparatus provided with a displaying unit capable of rotating a screen. The electronic apparatus includes: a sensor configured to detect at least one of an acceleration, a velocity and an angular velocity of a body of the electronic apparatus as a detection value; a microcomputer configured to determine whether the screen is to be rotated or not, based on the detection value; and a control section configured to control whether or not to allow the displaying unit to rotate the screen, based on a determination result by the microprocessor. The microcomputer enter a power save mode in a case where a change of the detection value is equal to or less than a fixed level for a given time period.

### CROSS-REFERENCE TO RELATED APPLICATION(S)

This application claims priority from U.S. Provisional Patent Application No. 61/932,673 filed on Jan. 28, 2014, the entire contents of which are incorporated herein by reference.

### TECHNICAL FIELD

The present invention relates to an electronic apparatus and a control method for the same.

### BACKGROUND ART

The power saving control of an automatic screen rotation function using an acceleration sensor may involve following problems.

An information apparatus such as a PC, a tablet and a smartphone is likely to have a sensor hub. The sensor hub may be connected with an acceleration sensor, a gyro sensor and the like, for managing the sensors and for processing and outputting of sensor information. On the other hand, a system OS may have functions of, in the case where the apparatus is tilted or rotated, determining the direction of the apparatus based on the inclination value of the gyro sensor upon a specific change of the acceleration sensor value as a trigger, and automatically rotating a screen in accordance with the direction. Thus, particularly in view of these functions, a sensor hub is often used.

In the case where a sensor hub is connected through a USB, upon duration of given time without the change in the detection value of the acceleration sensor, the sensor hub may set the sensor to a selective suspend mode such that an interruption occurs upon the change in the detection value of the acceleration sensor, and also the sensor hub itself enters a power save mode, thereby performing power saving.

However, depending on the situation, an acceleration sensor may need to return from the power save mode by sensitively detecting a motion of an apparatus depending on the situation. In view of this, the acceleration sensor tends to return from the power save mode with vibration or motion which is so small that such a return is actually not necessary. Nevertheless, a sensor hub sends the change of the sensor value to the system, and therefore, also a USB bus is immediately caused to return from the selective suspend state.

In an apparatus system, however, the increase of power consumption due to the returning of a USB bus from the selective suspend mode is larger than that due to the returning of a sensor hub from the power consumption (in a certain OS system, 0.2 to 0.3 W). Therefore, the increase of system power consumption due to unwanted returning of a USB from the selective suspend mode becomes problematic.

### BRIEF DESCRIPTION OF THE DRAWINGS

FIG. 1 perspective view showing the appearance of an electronic apparatus of an embodiment.

FIG. 2 A block diagram showing the system configuration of the electronic apparatus of the embodiment.

FIG. 3 A system diagram of an information apparatus of the embodiment.

FIG. 4 A control flowchart of a sensor hub microcomputer in the embodiment.

FIGS. 5A and 5B Views showing temporal acceleration changes in the embodiment.

FIG. 6 A view showing an acceleration sensor use request register in the embodiment.

### MODE FOR CARRYING OUT THE INVENTION

An embodiment will be described with reference to the drawings.

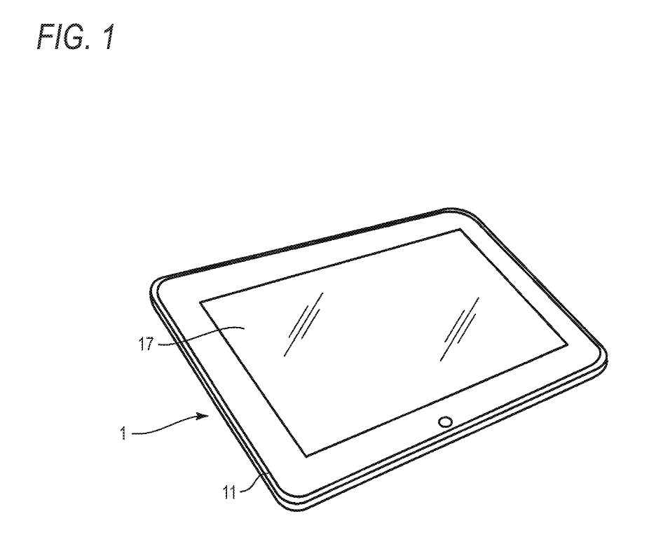

FIG. 1 is a perspective view showing the appearance of an electronic apparatus of an embodiment. For example, the electronic apparatus is a portable electronic apparatus. The electronic apparatus may be realized as a tablet computer, a notebook personal computer, a smartphone, a PDA, or the like. Hereinafter, a tablet computer 1 is exemplified as the electronic apparatus. The tablet computer 1 is a portable electronic apparatus which is also called a tablet or a slate computer, and, as shown in FIG. 1, includes the body 11 and a touch screen display (display device, displaying means) 17. The touch screen display 17 is attached so as to be overlaid on the upper surface of the body 11.

The body 11 has a thin box-like case. A flat panel display, and a sensor which is configured so as to detect a contact position of the finger on the screen of the flat panel display are incorporated in the touch screen display 17. For example, the flat panel display may be a liquid crystal display (LCD). As the sensor, for example, an electrostatic capacitance type touch panel or the like may be used.

A touch panel 17B is disposed so as to cover the screen of the flat panel display. The touch screen display 17 can detect a touch operation which is performed on the screen by using the finger.

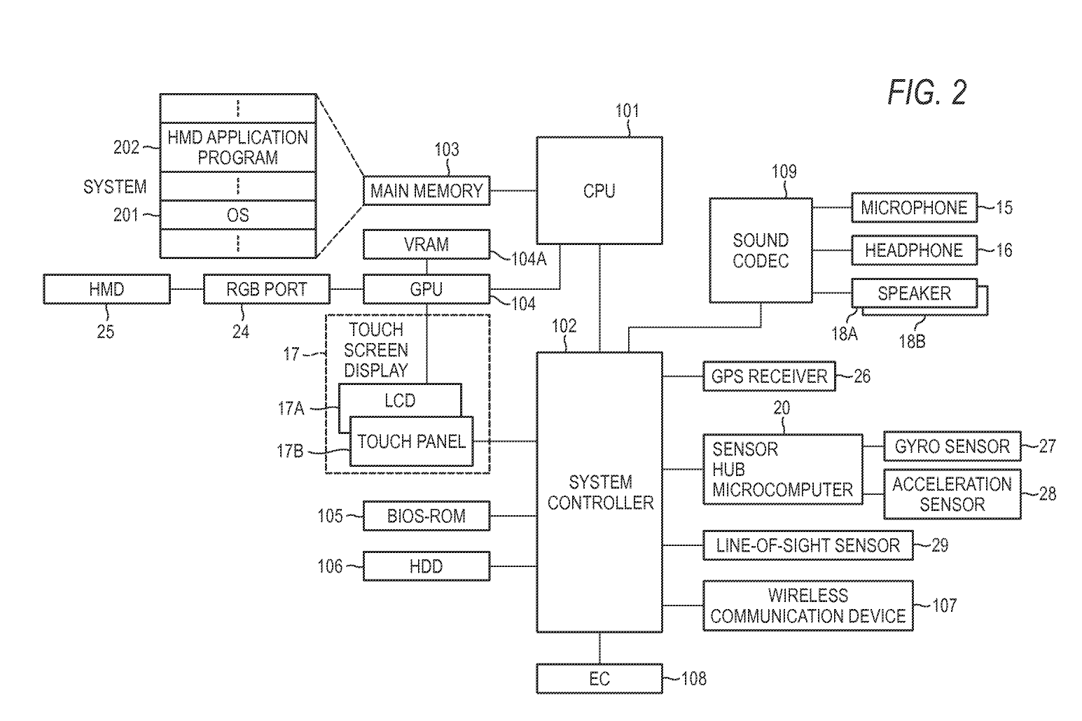

FIG. 2 shows the system configuration of the computer 1.

The computer 1 includes a CPU 101, a system controller 102, a main memory 103, a graphics processing unit (GPU) 104, a BIOS-ROM 105, a hard disk drive (HDD) 106, a wireless communication device 107, an embedded controller IC (EC) 108, a sound codec 109, etc.

The CPU 101 is a processor which controls the operations of the components of the computer 1. The CPU 101 executes various kinds of software which are loaded from the HDD 106 onto the main memory 103. The software includes an operating system (OS) 201, and various application programs. The application programs include an HMD application program 202. The HMD application program 202 is a program for executing a function of controlling information (electronic information) to be displayed on an HMD 25.

The CPU 101 executes also a basic input output system (BIOS) stored in the BIOS-ROM 105 which is a non-volatile memory. The BIOS is a system program for hardware control.

The GPU 104 is a display controller which controls an LCD 17A employed as a display monitor of the computer 1. The GPU 104 generates a display signal (LVDS signal) which is to be supplied to the LCD 17A, from display data stored in a video memory (VRAM) 104A. Furthermore, the GPU 104 generates an analog RGB signal and an HDMI (registered trademark) video signal from the display data. The analog RGB signal is supplied to the head mount display (HMD) 25 via an RGB port 24. The GPU 104 may send, through an HDMI (registered trademark) output terminal, an HDMI (registered trademark) video signal (non-compressed digital video signal) and a digital audio signal to the HMD 25 by means of one cable.

The HMD 25 is a transmissive HMD. On a display of the HMD 25, a real world is transmitted, and video (image) based on a video signal which is sent by the GPU 104 is displayed. When the user wears the HMD 25, the display of the HMD 25 is placed, for example, in front of the eye of the user. The user wearing the HMD 25 can view both the real world viewed through the display, and various information displayed on the display. Namely, the user can view the information laid over (overlapped with) the real world. For example, the displayed information is location-dependent information (e.g., information on directions, information on nearby facilities) which is suited to the user who is moving. Therefore, the above-described HMD application program 202 controls, for example, so that information corresponding to a position of movement of the user is displayed on the display of the HMD 25 in accordance with the movement of the user.

The system controller 102 is a bridge device which makes connection between the CPU 101 and each of the components. The system controller 102 incorporates a serial ATA controller for controlling the hard disk drive (HDD) 106. Furthermore, the system controller 102 executes communication with each of devices on an LPC (Low PIN Count) bus.

The system controller 102 is connected to a GPS receiver 26, a gyro sensor 27, an acceleration sensor 28, and a line-of-sight sensor 29 via a serial bus such as a USB. The GPS receiver 26 is a device which receives GPS data transmitted from plural GPS satellites. Using the received GPS data, the GPS receiver 26 calculates the present position, altitude, and the like of the user. The GPS receiver (position sensor) 26 outputs position data indicative of the position of the user to the system controller 102, for example, at regular time intervals (e.g., in every second).

The gyro sensor 27 detects the angular velocity. The gyro sensor 27 supplies data indicative of the angular velocity to the system controller 102.

The acceleration sensor 28 detects the acceleration of movement of the user (computer 1). For example, the acceleration sensor 28 is a three-axis acceleration sensor which detects accelerations in three axes (X, Y, and Z). Using the detected accelerations, the acceleration sensor 28 can detect also the moving velocity of the user. The acceleration sensor (velocity sensor) 28 outputs velocity data indicating the moving velocity of the user to the system controller 102, for example, at regular time intervals (e.g., in every 0.1 second).

Each of the GPS receiver 26, the gyro sensor 27, and the acceleration sensor 28 may be built in the computer body 11, or may be connected by wire via various terminals disposed on the computer 1. In addition, each of the GPS receiver 26, the gyro sensor 27, and the acceleration sensor 28 may be wirelessly connected to the computer 1 via a communication module such as Bluetooth (registered trademark) disposed on the computer 1.

The line-of-sight sensor 29 detects the line of sight of the user wearing the HMD 25. By using the detected line of sight, the line-of-sight sensor 29 can specify the area of the display (screen) of the HMD 25 which the user is viewing. The line-of-sight sensor 29 is attached to, for example, an upper part of the HMD 25 in a direction in which the line of sight can be detected. In the case where the HMD 25 is realized in a shape of eyeglasses, for example, the line-of-sight sensor 29 is attached to an upper part of a lens portion in a direction in which the user's eye can be detected. The line-of-sight sensor 29 may be built in the display (screen) of the HMD 25. The line-of-sight sensor 29 supplies line-of-sight data indicating the line of sight of the user to the system controller 102.

The data which are output from the above-described various sensors are used by, for example, the HMD application program 202.

The system controller 102 has also a function of communicating with the sound codec 109. The sound codec 109 is a sound source device, and outputs audio data which are a target of playback, to a headphone 16 or speakers 18A, 18B. In addition, the sound codec 109 supplies audio data which are detected by a microphone 15, to the system controller 102.

The EC 108 is connected to an LPC bus. The EC 108 is implemented as a one-chip microcomputer incorporating a power management controller which executes power management of the computer 1. The EC 108 has a function of powering ON and OFF the computer 1 in response to an operation by the user on the power switch.

The wireless communication device 107 is a device configured so as to execute wireless communication such as wireless LAN or 3G mobile communication.

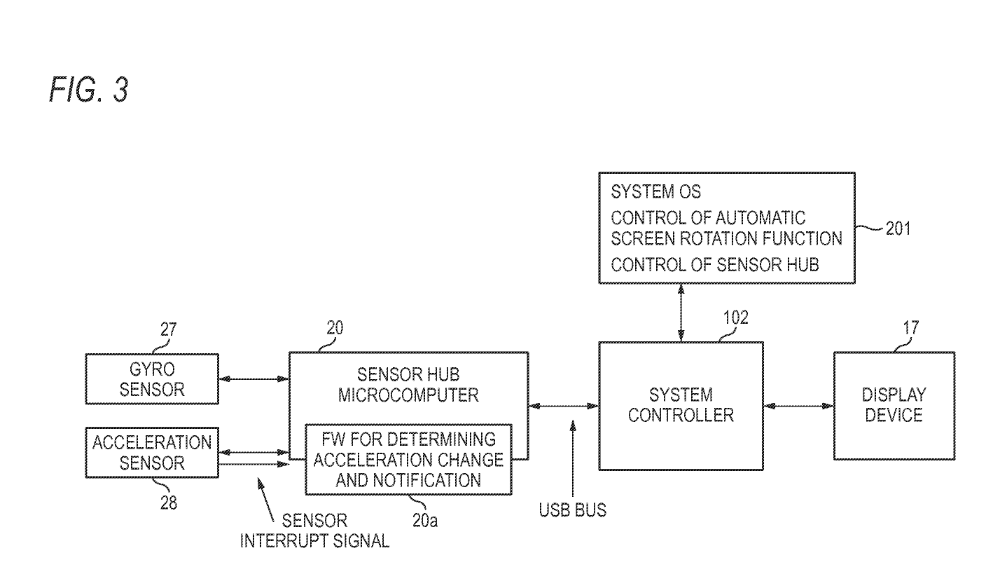

FIG. 3 is a function diagram of an information apparatus system based on the configuration of the computer 1 of the embodiment.

As shown in FIG. 3, the information apparatus system has the configuration of an information apparatus system including: sensors such as the acceleration sensor 28 and the gyro sensor 27; a sensor hub microcomputer 20 which manages and processes information supplied from the sensors, which has a function of notifying it to the OS 201 (hereinafter, referred to as system OS), and which is connected to the system controller 102 via the USB bus; and the system OS having a control function of detecting the inclination and rotation of the apparatus based on the sensor information supplied from the sensor hub microcomputer 20, and automatically rotating the screen.

In the case where a change of the acceleration value is equal to less than a fixed level for a given time period, the sensor hub microcomputer 20 causes the USB bus to enter the selective suspend mode which is a power save mode, causes the acceleration sensor 28 to enter the power save mode while setting such that it will issue an interruption upon the change in the value of the acceleration sensor by a given level.

The sensor hub microcomputer 20 itself enters the power save mode while setting such that it is returnable upon the interruption from the acceleration sensor 28.

After entering the power save mode, when the value of the acceleration sensor is changed by the given level, the acceleration sensor 28 issues an interruption, the sensor hub microcomputer 20 returns from the power save mode and starts to operate, and firmware 20a which causes the acceleration sensor 28 to return to a normal mode, and which determines an acceleration change on the microcomputer, and notification of the change monitors a change of the acceleration sensor value of the acceleration sensor 28 for a given time period, and, in the case where the possibility of the rotation of the information apparatus is detected from the change pattern, causes the USB bus to return from the selective suspend mode to the normal mode.

Then, the sensor hub microcomputer 20 notifies the system OS of the acceleration sensor value via the system controller 102, and, by using a change of the acceleration sensor value as a trigger, the system OS causes the function of automatically rotating the screen to operate, based on a change pattern of the acceleration sensor value, the inclination value of the gyro sensor 27, and the like. Namely, the system OS functions as a control section which controls the control whether the displaying means rotates the screen or not.

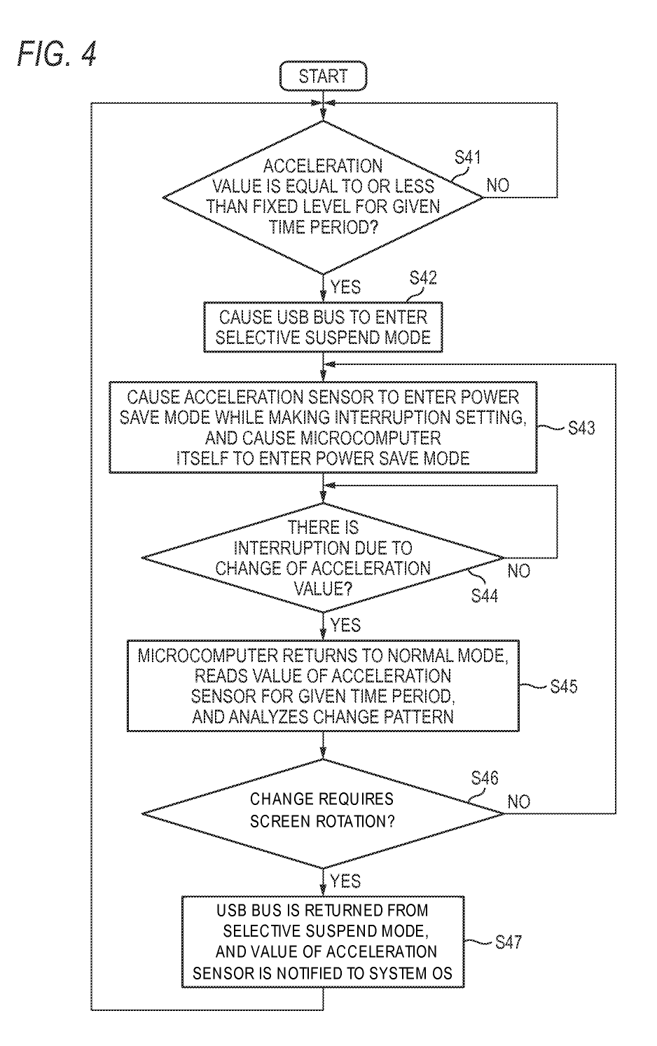

FIG. 4 is a control flowchart of the sensor hub microcomputer 20 (hereinafter, referred to as microcomputer) in the embodiment.

Step S41: The microcomputer determines whether the change of the acceleration value is equal to or less than the fixed level for the given time period or not. If the determination is No, the determination is repeated, and, if Yes, the process proceeds to the next step.

Step S42: The microcomputer causes the USB bus to enter the selective suspend mode.

Step S43: The microcomputer causes the acceleration sensor 28 to enter the power save mode while making the interruption setting. Also the microcomputer itself enter the power save mode.

Step S44: The microcomputer determines whether there is an interruption due to a change of the acceleration value or not. If the determination is No, the determination is repeated, and, if Yes, the process proceeds to the next step.

Step S45: The microcomputer returns to the normal mode, reads the acceleration sensor value of the acceleration sensor 28 for a given time period, and analyzes the change pattern of the value.

Step S46: The microcomputer determines whether the change is a change which requires the screen rotation to be performed or not. If the determination is No, the process returns to step S43, and, if Yes, the process proceeds to the next step.

Step S47: The microcomputer causes the USB bus and the like to return from the selective suspend mode, and notifies the system OS of the acceleration sensor value.

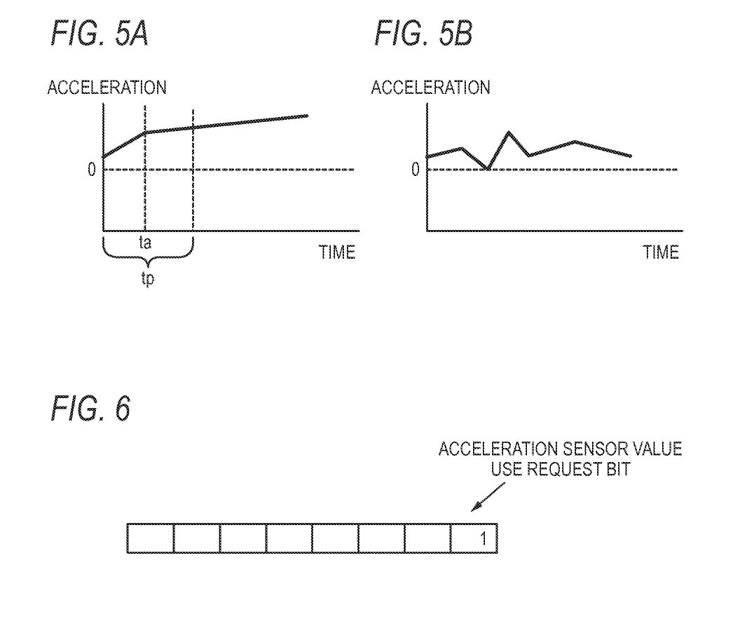

FIGS. 5A and 5B are schematic views showing temporal acceleration changes in the embodiment. FIG. 5A shows a case where the temporal change of the acceleration is large at time to but relatively moderate as a whole, and FIG. 5B shows that where the temporal change of the acceleration frequently occurs.

The firmware on the sensor hub microcomputer 20 in the embodiment detects a situation where the user starts to rotate or tilt the apparatus, based on a fact that the change of the acceleration value is continuously increased for a given time period (tp) as shown in FIG. 5A. In the case where the temporal change of the acceleration is vibrational, for example, the acceleration value is repeatedly increased and decreased as shown in FIG. 5B, or becomes 0 for a short time period.

FIG. 6 is a view showing a use request register of the acceleration sensor 28 in the embodiment. The use request register is developed on the main memory 103 by the OS 201. In the information apparatus system of the embodiment, as shown in FIG. 6, a register indicating that software other than the system OS which realizes the automatic screen rotation function requests the use of the acceleration sensor is added to an application programming interface (API) of the sensor hub, and software which uses the acceleration sensor for a purpose other than the automatic screen rotation sets a bit indicative of a use other than the automatic screen rotation, in the register before using the acceleration sensor.

In the case where the bit is set, based on the change pattern of the acceleration value of FIGS. 5A and 5B, sensor hub control software of the system OS instructs the sensor hub microcomputer to disable a function of determining whether the change of the acceleration value is to be notified to the system OS or not, and the sensor hub microcomputer notifies all changes of the acceleration value to the system OS.

As a result of the notification, a necessary change of the acceleration value is allowed to be obtained in the case where other software uses the acceleration sensor.

When the software which uses the acceleration sensor is to be ended, the software clears the set bit. When the function of, based on the change pattern of the acceleration value, determining whether the change of the acceleration value is to be notified to the system OS or not is again enabled, therefore, the power consumption of the system can be reduced. For example, game software may be assumed as the HMD application program. For example, it is assumed that a play environment which simulates the spatial position, attitude, and the like of the user is displayed on the touch screen display 17, and on the other hand materials (determination of the direction of movement, motion, and options of the execution) of an action in an aspect of the environment are displayed on the HMD 25. For example, the acceleration sensor is used with respect to motions of the head, line of sight, and the like of the user. It may result in the dynamic game progression.

As described above, the power consumption of the system can be reduced by means for monitoring a change of the acceleration sensor value for a given time period, determining based on the change pattern whether automatic screen rotation is necessary or not, and then causing the USB bus to return from the selective suspend mode.

In the above, the system for controlling the power saving of the automatic screen rotation function has been described. Points of the system will be supplementally described.

(1) In order to solve the problem, in the embodiment, in the information apparatus (system) including: the sensors such as the acceleration sensor; the sensor hub microcomputer which manages and processes information supplied from the sensors, which has the function of notifying it to the system OS, and which is connected to the system via the USB bus; and the system OS having the function of detecting the inclination and rotation of the apparatus based on the sensor information supplied from the sensor hub microcomputer, and automatically rotating the screen, the firmware which detects a situation where an operation such as tilting or rotating of the information apparatus is started, based on a change of the acceleration sensor value, and which determines whether the automatic screen rotation is required or not is disposed on the sensor hub microcomputer, and the control in which the apparatus returns from the selective suspend mode that is a power save mode of the USB bus, only when an acceleration change that requires an automatic rotation of the screen of the information apparatus is detected, and the acceleration change is notified to the system OS is added to the related-art system.

As a creative point, “the sensor hub microcomputer is provided with the functions of, even when a change of the acceleration value occurs, determining whether the change of the acceleration value is a change which requires rotation of the screen, or not based on the change pattern of the acceleration value, and determining whether the change of the acceleration value is to be notified to the system OS or not, and the return from the USB selective suspend mode is controlled by a result of the determination, thereby reducing or eliminating unwanted returns”.

(2) As another creative point, the firmware of the sensor hub microcomputer detects a situation where the user starts to rotate or tilt the apparatus based on a fact that the change of the acceleration value is continuously increased for a given time period (e.g., on the order of seconds). That is, the firmware of the sensor hub microcomputer executes a part of the process which has been executed by the system OS, and which detects a change of the acceleration value that functions as a trigger of the automatic screen rotation function, whereby an unwanted acceleration change is not notified to the system OS.

(3) As still another creative point, in the information apparatus, the arrangement for determining a situation where software other than the software which realizes the automatic screen rotation function requests the use of the acceleration sensor is provided in the application programming interface of the sensor hub. In the case where the acceleration sensor is used for a purpose other than the automatic screen rotation, therefore, the function of determining whether the acceleration change is to be notified to the system OS or not is disabled, and all changes of the acceleration value are notified to the OS, thereby preventing a failure from occurring even in the case where another application program uses the value of the acceleration sensor.

That is, the application programming interface of the sensor hub is provided with the arrangement for determining whether software other than the automatic screen rotation function which uses most frequently the value of the acceleration sensor requests the value of the acceleration sensor or not.

The invention is not limited to the embodiment, and may be implemented by modifying in various manners without departing from the spirit of the invention.

Plural components disclosed in the above-described embodiment may be appropriately combined with each other, whereby various inventions may be formed. For example, some components may be omitted from the whole components indicated in the embodiment, and moreover components of different embodiments may be adequately combined with each other.

1. An electronic apparatus provided with a displaying unit capable of rotating a screen, the electronic apparatus comprising:
a sensor configured to detect at least one of an acceleration, a velocity and an angular velocity of a body of the electronic apparatus as a detection value;
a microcomputer configured to determine whether the screen is to be rotated or not, based on the detection value; and
a control section configured to control whether or not to allow the displaying unit to rotate the screen, based on a determination result by the microprocessor,
wherein the microcomputer enter a power save mode in a case where a change of the detection value is equal to or less than a fixed level for a given time period.

2. The electronic apparatus of claim 1,
wherein the microcomputer determines whether the screen is to be rotated or not, based on the acceleration or the velocity, and the angular velocity.

3. The electronic apparatus of claim 1,
wherein, in the power save mode, a USB bus which is controlled by the microcomputer is set to a selective suspend mode.

4. A control method for an electronic apparatus provided with a displaying unit capable of rotating a screen, the control method comprising:
detecting at least one of an acceleration, a velocity and an angular velocity of a body of the electronic apparatus as a detection value by a sensor;
determining whether the screen is to be rotated or not, based on the detection value;
controlling whether or not to allow the displaying unit to rotate the screen, based on a determination result by the step of determining; and
entering a power save mode in a case where a change of the detection value is equal to or less than a fixed level for a given time period.
